(19) United States
(12) Patent Application Publication
(10) Pub. No.: US 2010/0282931 A1
(43) Pub. Date: Nov. 11, 2010

(54) SHEAVE SUPPORTING ELEMENT FOR USE IN WINDOW REGULATOR GUIDE SECTIONS

(76) Inventor: Melchor Daumal Castellon, Barcelona (ES)

Correspondence Address: DOWELL & DOWELL P.C., 103 Oronoco St., Suite 220, Alexandria, VA, 22314, US

(21) Appl. No.: 12/451,905

(22) PCT Filed: Aug. 8, 2007
(86) PCT No.: PCT/ES2007/000484

§ 371 Date: Dec. 4, 2009

(30) Foreign Application Priority Data
Jun. 14, 2007 (ES) U200701275

(51) Int. Cl. F16B 47/00

(52) U.S. Cl. 248/206.2

(57) ABSTRACT

The invention relates to a supporting element which takes the form of an angle bar. Suitable means are used to provide the bar with a cable guide sheave and the supporting element and the sheave, together with the aforementioned means, are mounted on a guide section of the type used in window regulators. Preferably, a supporting element and a sheave are provided close to each of the ends of the above-mentioned section.

The present invention relates to a supporting element which takes the form of an angle bar. Suitable means are used to provide the bar with a wire guide sheave; the supporting elements and the sheave, together with the aforementioned means, are mounted on a guide section of the type used in window-regulating devices. Preferably, a supporting element and a sheave are provided close to each of the ends of the aforementioned section.

The supporting element itself is made up of a bar that is preferably metallic, with an angular body, the vertical part being flat, and the upper base being curved, with a central opening in its perimeter, from which a small tab protrudes perpendicular to the vertical part, while the horizontal part is concave.

On the market, there are different types of supports for sheaves that can be considered the state of the art, to fit them into guide sections in window-regulating devices; however, the function is merely that of a supporting element, unlike the supporting element that is the object of the invention, which includes other additional functions, such as:
A stopper for wire covers.
An element for achieving an adjustable position.
A support surface for the sheave.

The sheaves in window regulators lead the wire, which acts as a mechanism for dragging the window glass of the automobile; around its perimeter there is a groove that holds and guides this wire. Due to the weight of the glass and its rubbing against the joints in the frame of the window, the sheaves and their turn shaft are subject to a great deal of force, as well as the corresponding wire, which means that the bar must be very sturdy without increasing its weight very much, and the sheaves must turn with respect to the supporting element and the profile guide, without any play.

In order to fulfil the new functions, the supporting element that is the object of the invention has a ring cup on its vertical part, which serves as a support when the sheave turns, and prevents it from making lateral movements, thus preventing the wire from slipping off the sheave.

On the upper base of the vertical part, as described above, there is a perpendicular tab that, when the support is placed in the guide section, is entered in one of the drilled holes forming a circular line on the aforementioned section, and the supporting element is placed in the appropriate position in regard to the section; this is to say that the supporting element can be placed in the position desired, so it can adapt to the window-regulating device surrounding conditions or shape.

The horizontal part of the supporting element and its concave plane include a pair of openings for the fitting of the wire covers, so that it acts as a stopper for these covers and prevents the dragging of the covers inside when the wire moves.

The sheave and the supporting element are attached to the guide section by a drilled hole, into which the corresponding end is entered, acting as the shaft of the sheave, later riveted at the ends.

Other details and characteristics shall be shown throughout the description below referring to drawings attached to this report which are shown for illustrative but not limiting purposes a practical embodiment of the invention.

Below is a detailed list of the different parts of the invention which are shown in the figures attached to this report:
(10) supporting element.
(11) sheave.
(12) drilled hole.
(13) vertical part.
(14) horizontal part.
(15) ring cup.
(16) support surface.
(17) tab.
(18) groove.
(19) opening.
(20) riveted shaft.
(21) guide section.
(22) line of drilled holes.
(23) covers.
(24) wires.
(25) drilled hole on the sheave (11).
(26) drilled hole on the guide section (21).

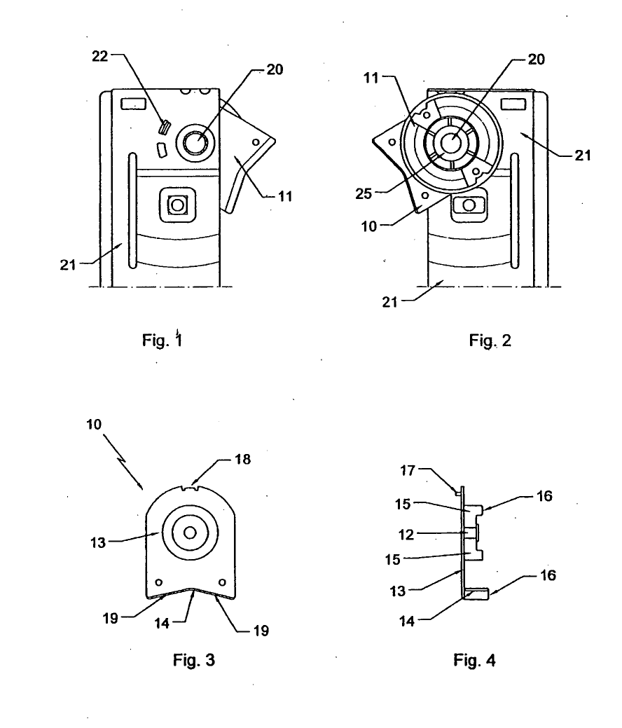

FIG. 1 is a front elevation view of a guide section (21), in which the supporting element (10) and the sheave (11) are assembled using rivets (20) on the back side.

FIG. 2 is a front elevation view of a guide section (21), in which the supporting element (10) and the sheave (11) are assembled using rivets (20) on the front side.

FIG. 3 is a front elevation view of the supporting element (10).

FIG. 4 is a side elevation view of the supporting element (10).

In one of the preferred forms of the device that is the object of the present invention, and as can be seen in FIGS. 3 and 4, the supporting element (10) has a vertical part (13) that is noticeably flat and affected by a ring cup (15), the central part of which holds the drilled hole (12) for the housing of the rivet shaft (20).

The upper base of the flat part has a semi-circular configuration, and in its central part, there is a groove (18), from the lower base of which the tab (17) sticks out perpendicularly to the aforementioned flat part (13), which fits as may be seen in FIG. 1 with a line of drilled holes (22), placed in the guide section (21).

The horizontal part (14) of the supporting element (10), as can be seen in FIGS. 3 and 4, is made up of a convex plane that has some openings (19) into which the ends of the covers (23) of the wires (24) fit, not shown in the figures.

The alignment and orientation of the supporting element (10) comes from the combination of the tab (17) with the aforementioned line of drilled holes (22) placed in the guide section (21).

The joining of the supporting element (10) to the guide section (21) comes from the shaft (20) that also acts as a rivet (20), which crosses the drilled hole (12) of (10) and the drilled hole (25) in the sheave (11), so that the supporting element (10) is fixed to the guide section (21), but the sheave (11) may turn freely around the rivet shaft (20).

The prevision of a cup (15) in the vertical part (13) of the supporting element (10) assures a gentle rubbing against the lateral surface of the sheave (11), so that said lateral surface of (11) rests on the points (16) of the cup (15), ensuring that there is not any play. Having sufficiently described this invention using the Figures attached, it is easy to understand that any changes judged to be suitable may be made, whenever these changes do not alter of the essence of the invention summarised in the following claims.

1. “IMPROVED SHEAVE SUPPORTING ELEMENT FOR USE IN WINDOW REGULATOR GUIDE SECTIONS” that include at the ends of a guide section supports and sheaves that hold a wire, intended to act as the means of dragging a sheet of glass in the frame of an automobile door characterised by the fact that the supporting element (10) is made up of a metal bar folded at an angle, the vertical part of which (13) has a ring cup (15) and in the central part (15), a drilled hole (20) with a horizontal part (14) on the lower base that is a concave surface with some openings (19), while the upper base of the vertical part (13) has a groove (18) with a tab (17) sticking out perpendicularly from its lower base (13).

2. “IMPROVED SHEAVE SUPPORTING ELEMENT FOR USE IN WINDOW REGULATOR GUIDE SECTIONS” according to the claim 1 characterised by the fact that the alignment and orientation of the supporting element (10) with respect to the guide section (21) are assured thanks to the combination of the tab (17) fitting into any one of the drilled holes of the line (22).

3. “IMPROVED SHEAVE SUPPORTING ELEMENT FOR USE IN WINDOW REGULATOR GUIDE SECTIONS” according to the claim 1 characterised by the fact that the supporting element (10) and the sheave (11) are incorporated into the ends of the guide section (21) with the help of a rivet shaft (20) that passes through the central part of the sheave (11) and through the drilled hole (25) placed in it and the drilled hole (12) of the supporting element (10), crossing the drilled hole (26) of the guide section (21).

4. “IMPROVED SHEAVE SUPPORTING ELEMENT FOR USE IN WINDOW REGULATOR GUIDE SECTIONS” according to the claim 1 characterised by the fact that the lateral surface of the sheave (11) rests on the points (16) of the ring cup (15) in the vertical part (13) of the supporting element (10).
